(19) United States
(12) Patent Application Publication
(10) Pub. No.: US 2025/0025949 A1
(43) Pub. Date: Jan. 23, 2025

(54) CIRCULAR SAW WITH OVER ROTATION FEATURE

(71) Applicant: TECHTRONIC CORDLESS GP, Anderson, SC (US)

(72) Inventors: En Wei WANG, Dongguan City (CN); Ronald C. McCurry, West Union, SC (US)

(21) Appl. No.: 18/716,601

(22) PCT Filed: Dec. 17, 2021
(86) PCT No.: PCT/CN2021/139230

§ 371 Date: Jun. 5, 2024

(51) Int. Cl. B23D 45/16

(52) U.S. Cl. CPC B23D 45/16

(57) ABSTRACT

A circular saw (100) including a housing (102) and a motor (120) disposed within the housing. The circular saw also includes a blade removably coupled with the driveshaft (122) of the motor and operable to rotate therewith and a bottom plate (140) rotatably coupled to the housing. The bottom plate defines a zero plane (164) in which the blade is orthogonal to the bottom plate. The bottom plate rotates in a first direction from the zero plane and in a second direction from the zero plane opposite the first direction.

### BACKGROUND

The present invention relates to circular saws, and more particularly to circular saws including an over-rotation feature.

Most existing circular saws typically have a calibrated bevel function that allows the saw to tilt for angular, non-perpendicular cuts to a work piece. Typically, a set screw is used to set the 0° setting for the saw. Some existing saws have a bracket that keeps the base from over-tilting, but setting these saws to a true 0° setting can be difficult and sometimes results in having to bend the bracket. In addition, a bent bracket renders the bracket useless thereafter.

### SUMMARY

In one aspect, the present invention includes a circular saw that includes a housing and a motor disposed within the housing, the motor having a driveshaft. The circular saw also includes a blade removably coupled with the driveshaft of the motor and operable to rotate therewith and a bottom plate rotatably coupled to the housing. The bottom plate defines a zero plane in which the blade is orthogonal to the bottom plate. Moreover, the bottom plate rotates in a first direction from the zero plane and in a second direction from the zero plane opposite the first direction.

In another aspect, the invention includes a circular saw that includes a housing and a motor disposed within the housing, the motor having a driveshaft. The circular saw also includes a blade removably coupled with the driveshaft of the motor and operable to rotate therewith, a support bracket extending from the housing, the support bracket including a stabilizer tab, and a bottom plate rotatably coupled to the support bracket. The bottom plate includes a compressible pad configured to engage the support tab when the bottom plate is aligned along a zero plane in which the blade is perpendicular to the bottom plate.

Other features and aspects of the disclosure will become apparent by consideration of the following detailed description and accompanying drawings.

### BRIEF DESCRIPTION OF THE DRAWINGS

FIG. 1 is a perspective view of a circular saw in accordance with the present invention.

FIG. 2 is a first side view of the circular saw of FIG. 1.

FIG. 3 is a second side view of the circular saw of FIG. 1 with the motor cover removed.

FIG. 4 is a front view of the circular saw of FIG. 1 illustrating a baseplate of the circular saw oriented at a non-horizontal angle.

FIG. 5 is a rear view of the circular saw of FIG. 1.

FIG. 6 is a bottom view of the circular saw of FIG. 1.

FIG. 7 is a top view of the circular saw of FIG. 1.

FIG. 8 is another perspective view of the circular saw of FIG. 1.

FIG. 9 is a detailed view of the circular saw of FIG. 1 taken at Circle 9 in FIG. 8.

FIG. 10 is a detailed view of the circular saw of FIG. 1 with a stabilizer tab removed.

FIG. 11 is a detailed view of the circular saw of FIG. 1 with a compressible pad removed.

FIG. 12 is another perspective view of the circular saw of FIG. 1.

FIG. 13 is a detailed view of the circular saw of FIG. 1 taken at Circle 13 in FIG. 12.

Before any embodiments of the present invention are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

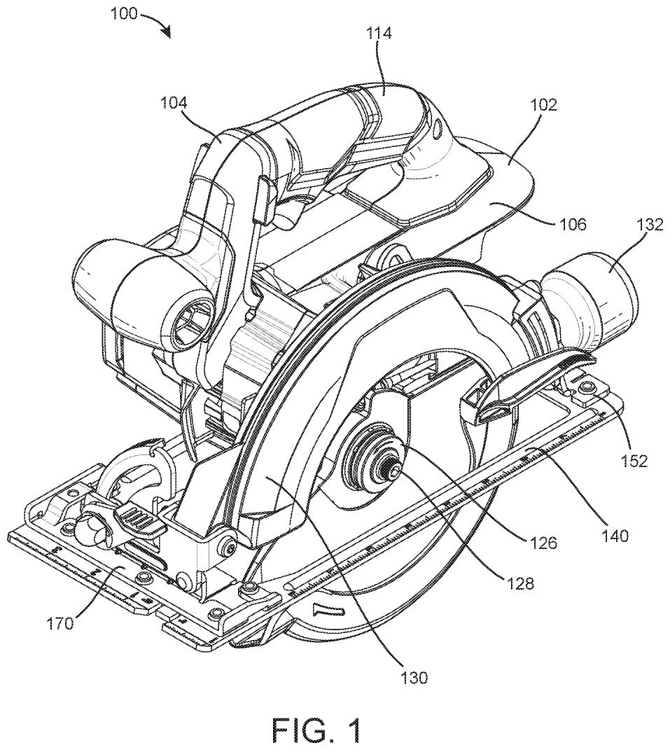

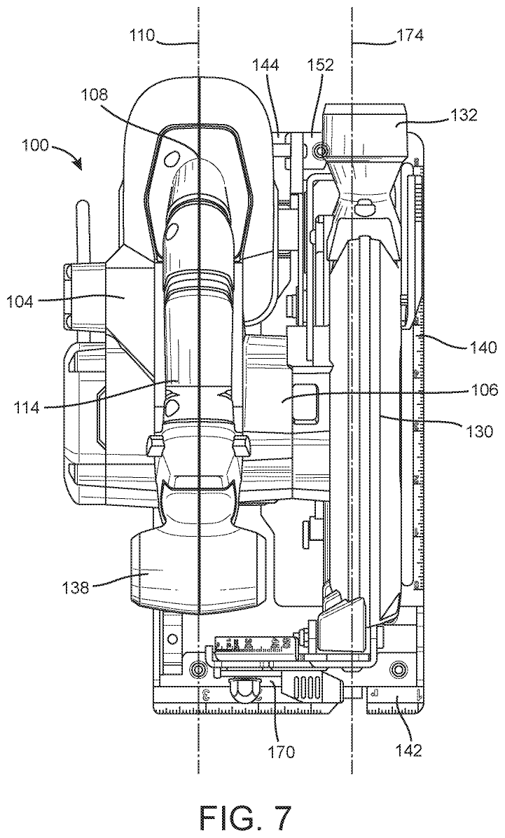

FIGS. 1-7 illustrate a circular saw 100 including a housing 102 that has a first housing portion 104 and a second housing portion 106. As best shown in FIG. 7, the housing portions 104, 106 meet to form an interface 108 that extends at least partially along a longitudinal axis 110. It is to be understood that the housing portions 104, 106 are attached, or otherwise affixed, to each other (e.g., via a plurality of fasteners such as screws, an adhesive, plastic welding, etc.).

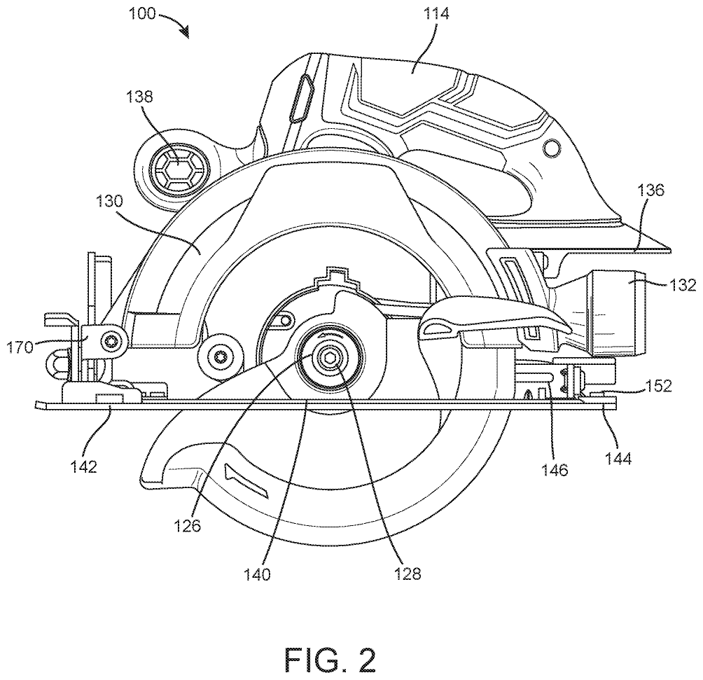

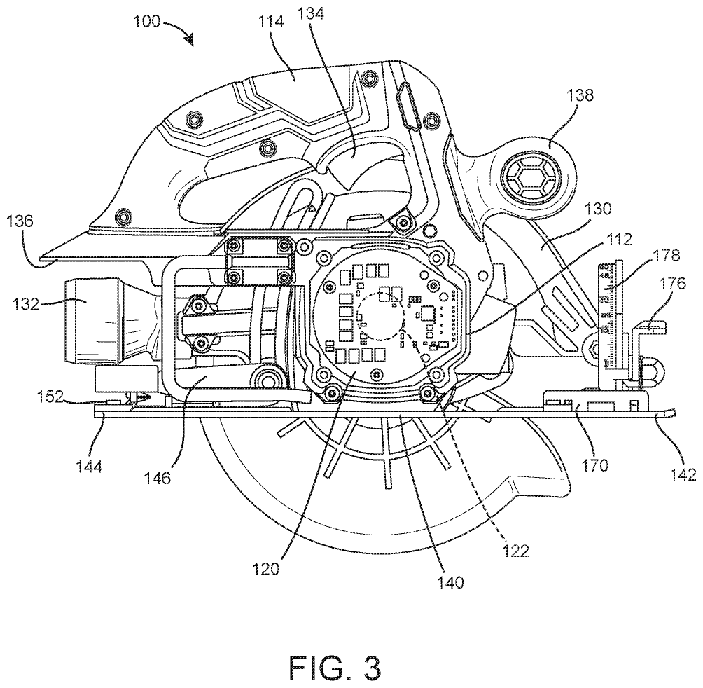

As best illustrated in FIG. 3, the housing 102 includes an interior or motor region 112 and a handle region 114. The motor region 112 includes a motor 120 that has a rotatable drive shaft 122. A saw blade (not shown) is coupled to the drive shaft 122 and rotates with the drive shaft 122 during operation. FIG. 1 and FIG. 2 show that the circular saw includes a blade flange 126 and a blade lock 128 (e.g., a bolt) that are used to removably engage the saw blade with the drive shaft 122. The circular saw 100 also includes a blade guard 130 that is affixed to, or otherwise disposed on, the housing 102. The blade guard 130 extends at least partially around the saw blade to protect a user from the rotating saw blade during operation, and to direct saw dust into a dust collector tube 132. The dust collector tube 132 may be coupled to a vacuum system hose (not shown). A dust collection bag (not shown) may be removably engaged with the dust collection tube 132.

As shown in FIG. 7, the circular saw 100 includes a trigger 134 in the handle region 114. The trigger 134 is operable to actuate the motor 120 and rotate the drive shaft 122. The handle region 114 of the housing 102 also includes a battery receptacle 136 that is sized and shaped to receive at least a portion of a removable battery pack. The battery pack may be engaged with the battery receptacle 136, and when the battery pack is engaged with the battery receptacle 136, the battery pack is electrically and operably coupled with the circular saw 100 via a battery connection to provide power to the motor 120 of the circular saw 100. It will be appreciated that the circular saw 100 may be powered by a corded connection. As illustrated, the circular saw 100 also includes a front handle 138 that is affixed to or otherwise attached the housing 102. As illustrated, the front handle 138 is affixed to and extends from the handle region 114 of the housing 102.

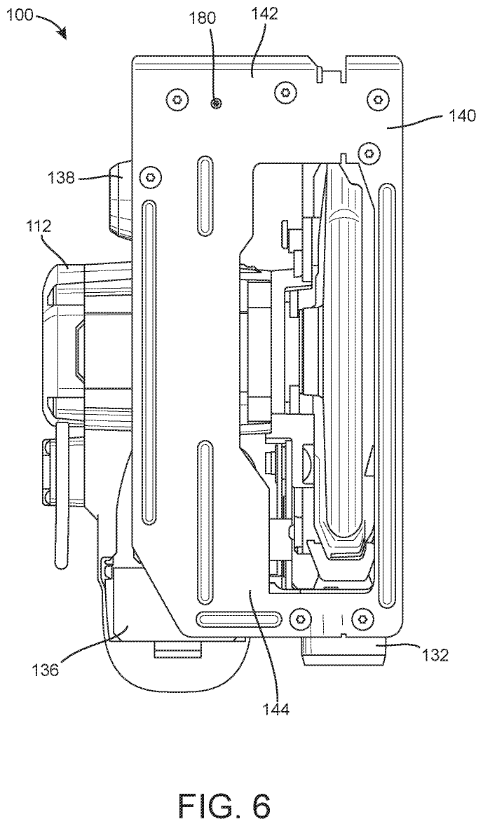

FIGS. 1-7 illustrates that the circular saw 100 includes a bottom plate 140 that is mounted to the housing 102. The bottom plate 140 acts as a guide during operation of the circular saw 100. In addition, the bottom plate 140 is movable or pivotable relative to the housing 102 in a first direction to change a depth of cut of the saw blade, and the bottom plate is separately movable in a second direction to change an angle of cut, or bevel, of the saw blade. As best show in FIG. 6 and FIG. 7 and based on the direction of travel during use of the circular saw 100, the bottom plate 140 defines a leading end 142 and a trailing end 144. It is to be understood that the leading end 142 of the bottom plate 140 is adjacent and below the front handle 138. The trailing end 144 of the bottom plate 140 is near, and below, the dust collection tube 132.

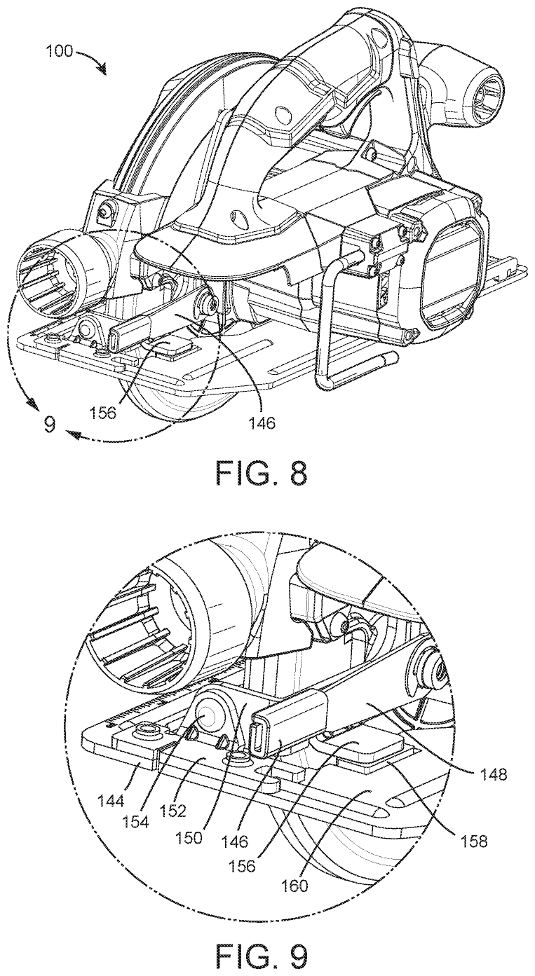

FIGS. 8-11 show that the trailing end 144 of the bottom plate 140 is connected to the housing 102 via a support bracket 146. The support bracket 146 includes a longitudinal arm 148 that extends from the housing 102 along a direction that is substantially parallel to the longitudinal axis 110. The support bracket 146 also includes a lateral tab 150 that extends perpendicularly from the longitudinal arm 148. The trailing end 144 of the bottom plate 140 includes a hinge bracket 152 that is affixed to the bottom plate 140. The lateral tab 150 is rotatably connected to the hinge bracket 152 at a trailing end hinge 154. As such, the bottom plate 140 of the circular saw 100 rotates relative to the housing 102 about the support bracket 146 at the trailing end hinge 154 that connects the lateral tab 150 and the hinge bracket 152.

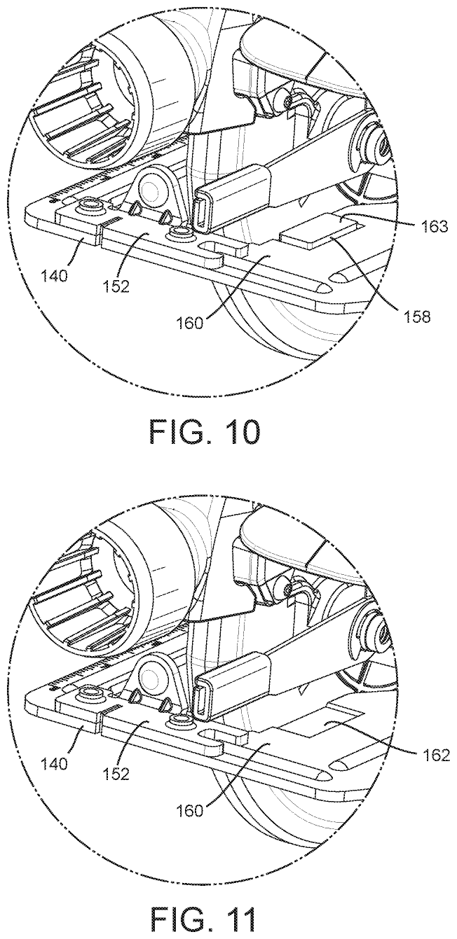

With reference to FIG. 9, the support bracket 146 includes a stabilizer tab 156 that extends perpendicularly from the longitudinal arm 148 in a direction opposite the lateral tab 150. The stabilizer tab 156 also is rotated ninety degrees with respect to the lateral tab 150 such that, when the stabilizer tab 150 is oriented along a plane in an X-Y direction, the lateral tab 150 is oriented along a plane in the X-Z direction, and the longitudinal arm 148 is oriented along a plane in the Y-Z direction. FIGS. 9-10 show that the circular saw 100 includes a pad 158 that is disposed on the bottom plate 140. More specifically, the bottom plate 140 includes an upper surface 160, and an indentation 162 extends into the bottom plate 140 from the upper surface 160. The indentation 162 is sized and shaped to receive the pad 158. The pad 158 is affixed to the bottom plate 140 within the indentation 162 (e.g., using an adhesive). As illustrated, a top surface 163 of the pad 158 is flush, or even, with the upper surface 160 of the bottom plate 140 when the compressible pad 158 is installed within the indentation 162 that is formed in the bottom plate 140. The pad 158 abuts the stabilizer tab 156 and supports the stabilizer tab 156.

In one example, the pad 158 is a compressible pad 158 (e.g., an elastomeric pad) that compresses and gets thinner due to a force placed upon it by the stabilizer tab 156. As such, the pad 158 includes an uncompressed thickness T_{U} when no force acts on the pad 158, and the pad 158 is compressible to a compressed thickness T_{C} with a force acting on the pad 158. The compressed thickness T_{C} is less than or equal to 99% of the uncompressed thickness T_{U}, and the compressed thickness T_{C} is greater than or equal to 85% of the uncompressed thickness T_{U}. The bottom plate 140 defines a thickness T_{b} and the indentation 162 has a depth D. The depth D is greater than or equal to 50% of the thickness T_{b}. In some embodiments, the depth D is less than or equal to 10% thickness T_{b}. It is to be understood that while an area of the pad 158 that contacts the stabilizer tab 156 compresses under the load, or force, placed upon it by the stabilizer tab 156, a portion of the pad 158 is displaced to accommodate that compression. For example, an outer peripheral surface of the pad 158 may bulge outward under load to allow the pad 158 to compress.

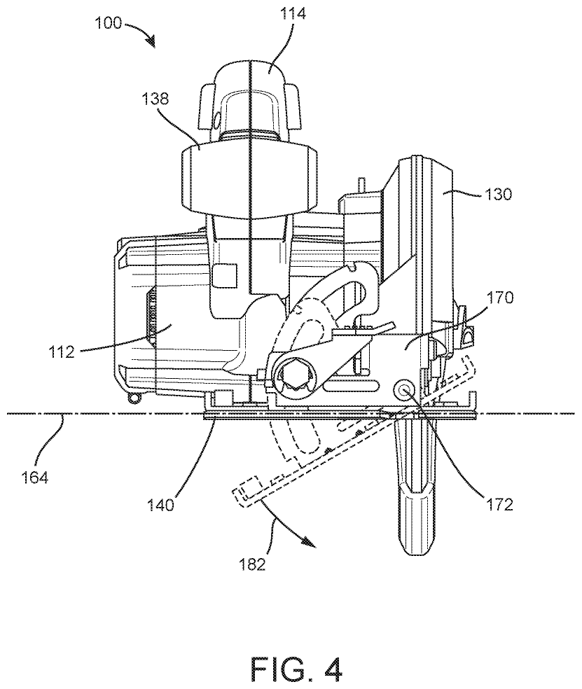

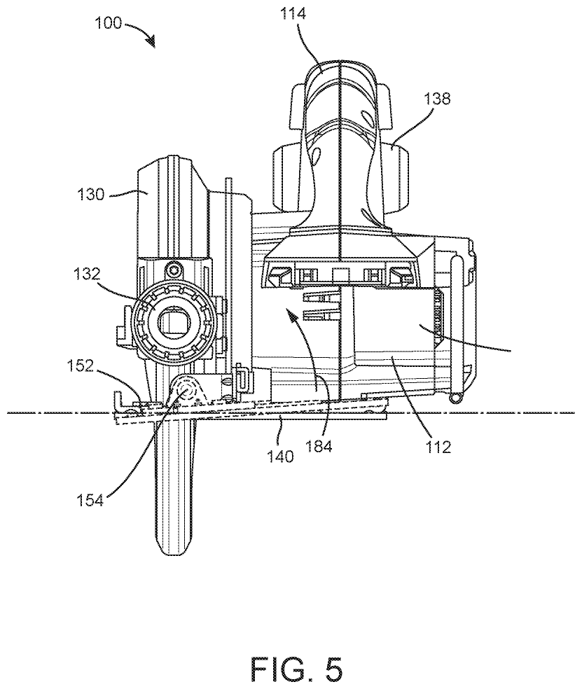

As best shown in FIGS. 4 and 5, the bottom plate 140 defines a zero plane 164 in which the saw blade is orthogonal, or perpendicular, to the bottom plate 140. As described in greater detail below, the bottom plate 140 is rotatable in opposite directions through the zero plane 164.

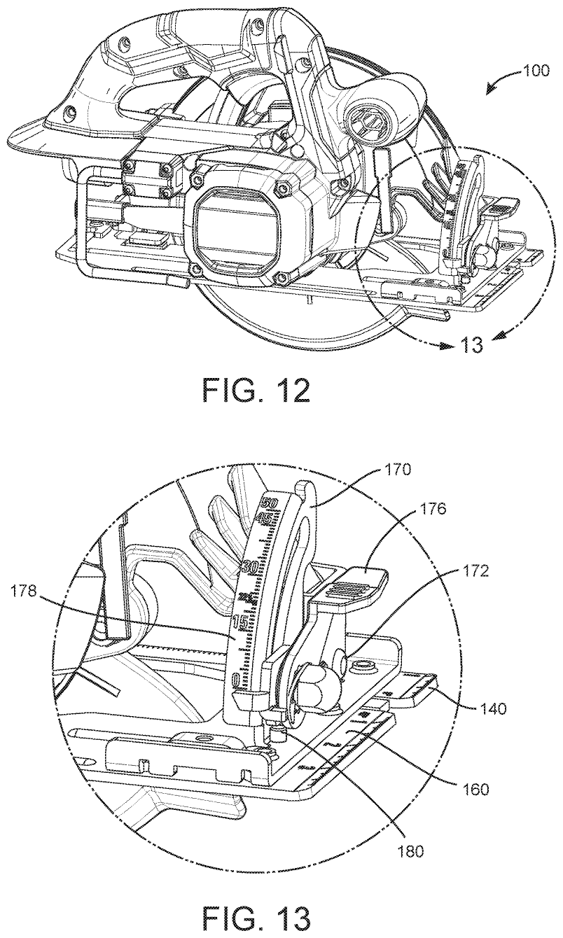

FIGS. 12 and 13 show that the leading end 142 of the bottom plate 140 includes a bevel bracket 170 that is coupled to the upper surface 160 of the bottom plate 140. The bevel bracket 170 incudes a leading end hinge 172 that is aligned with the trailing end hinge 154 along a hinge axis 174 (shown in FIG. 7). The bevel bracket 170 may also include an adjuster 176 and a bevel angle indicator 178. The adjuster 176 may be loosened to allow the bottom plate 140 to rotate about the hinge axis 174 that extends through the hinges 154, 172. The bevel bracket 170 also includes a set screw 180 that is used to adjust the bottom plate 140 relative to the housing 102 to ensure that the bottom plate 140 is aligned along the zero plane 164 at a bevel angle of zero degrees (0°).

During use, and with reference to FIG. 4 and FIG. 5, the bottom plate 140 may be rotated about the hinge axis 174 in a first direction from the zero plane 164, as indicated by arrow 182, and in a second direction from the zero plane 164, as indicated by arrow 184. The second direction of rotation is opposite the first direction of rotation. As shown in FIG. 4, the bottom plate 140 may rotate in the first direction over a range of zero degrees to fifty degrees (0°-50°). The bottom plate 140 also may rotate in the second direction, opposite the first direction, over a range of zero degrees to three degrees (0°-3°). It is to be understood that the pad 158 compresses as a force is applied to the pad 158 via the stabilizer tab 156 to allow the bottom plate 140 to rotate in the second direction. The bottom plate 140 can over-rotate or over-travel in the second direction to achieve a true bevel angle of zero degrees (0°). Then, using the set screw 180, the bottom plate 140 can be adjusted back to the zero plane 164. As such, the bottom plate 140 is adjustable so that the saw blade is as near as perpendicular, or orthogonal, to the bottom plate 140 as possible at a bevel angle of zero degrees (0°) while still allowing the stabilizer tab 156 to contact the bottom plate 140 to help support the rear area of the bottom plate 140. Without the pad 158, the stabilizer tab 156 would need to be bent to clear the bottom plate and would be useless for providing any additional bottom plate stabilization.

Although the invention has been described in detail with reference to certain preferred embodiments, variations and modifications exist within the scope and spirit of one or more independent aspects of the invention as described.

Various features of the invention are set forth in the following claims.

1. A circular saw comprising:
a housing;
a motor disposed within the housing, the motor having a driveshaft;
a blade removably coupled with the driveshaft of the motor and operable to rotate therewith; and
a bottom plate rotatably coupled to the housing, the bottom plate defining a zero plane in which the blade is orthogonal to the bottom plate, and the bottom plate is rotatable in a first direction from the zero plane and in a second direction from the zero plane opposite the first direction.

2. The circular saw of claim 1, wherein the bottom plate rotates in the first direction over a range of zero degrees to fifty degrees (0°-50°) and in the second direction over a range of zero degrees to three degrees (0°-3°).

3. The circular saw of claim 2, further comprising a support bracket adjacent to a first end of the bottom plate, wherein the support bracket connects the first end of the bottom plate to the housing, wherein the bottom plate rotates about the support bracket, and wherein the support bracket includes a stabilizer tab to support the bottom plate when engaged with the bottom plate at the zero plane.

4. The circular saw of claim 3, wherein the bottom plate includes a compressible pad configured to engage the stabilizer tab when the bottom plate is aligned along the zero plane.

5. The circular saw of claim 4, wherein the compressible pad compresses slightly when engaged with the stabilizer tab to allow the bottom plate to rotate in the second direction.

6. The circular saw of claim 4, wherein the compressible pad comprises an elastomeric pad.

7. The circular saw of claim 6, wherein the elastomeric pad includes an uncompressed thickness, T_{U}, and the elastomeric pad is compressible to a compressed thickness, T_{C}, that is less than or equal to 99% T_{U}.

8. The circular saw of claim 7, wherein T_{C} is greater than or equal to 85% T_{U}.

9. The circular saw of claim 4, wherein the bottom plate includes an indentation configured to receive the compressible pad.

10. The circular saw of claim 9, wherein the bottom plate defines a thickness, Tb, and the indentation comprises a depth, D, and D is greater than or equal to 50% Tb.

11. The circular saw of claim 10, wherein D is less than or equal to 10% Tb.

12. The circular saw of claim 3, further comprising a bevel bracket adjacent coupled to a second end of the bottom plate, wherein the bevel bracket connects the second end of the bottom plate to the housing, wherein the bottom plate rotates about the bevel bracket, and wherein the bevel bracket includes an adjustable set screw that is rotatable to a stop position in which the bottom plate is prevented from rotating in the second direction bracket from the zero plane.

13. A circular saw comprising:
a housing;
a motor disposed within the housing, the motor having a driveshaft;
a blade removably coupled with the driveshaft of the motor and operable to rotate therewith;
a support bracket extending from the housing, the support bracket including a stabilizer tab; and
a bottom plate rotatably coupled to the support bracket, the bottom plate including a compressible pad configured to engage the support tab when the bottom plate is aligned along a zero plane in which the blade is perpendicular to the bottom plate.

14. The circular saw of claim 13, wherein the bottom plate rotates in a first direction from the zero plane and in a second direction from the zero plane opposite the first direction.

15. The circular saw of claim 14, wherein the bottom plate rotates in the first direction over a range of zero degrees to fifty degrees (0°-50°).

16. The circular saw of claim 15, wherein the bottom plate rotates in the second direction over a range of zero degrees to three degrees (0°-3°).

17. The circular saw of claim 13, wherein the compressible pad compresses to allow the bottom plate to rotate in the second direction.

18. The circular saw of claim 13, wherein the compressible pad comprises and elastomeric pad.

19. The circular saw of claim 13, wherein the compressible pad is affixed to the bottom plate within an indentation in the bottom plate.

20. The circular saw of claim 20, wherein a top surface of the compressible pad is flush with an upper surface of the bottom plate when the compressible pad is installed within the indentation of the bottom plate.
